(19) United States
(12) Patent Application Publication
(10) Pub. No.: US 2026/0115763 A1
(43) Pub. Date: Apr. 30, 2026

(54) DRIVING SIGNAL GENERATION METHOD AND ULTRASONIC GENERATOR SYSTEM

(71) Applicant: National Taiwan University, Taipei City (TW)

(72) Inventors: Hao-Li LIU, Taoyuan City (TW); Chun-Mao CHEN, Taipei City (TW)

(73) Assignee: National Taiwan University, Taipei City (TW)

(21) Appl. No.: 18/990,063

(22) Filed: Dec. 20, 2024

(30) Foreign Application Priority Data
Oct. 30, 2024 (TW) 113141464

(51) Int. Cl. B06B 1/02

(52) U.S. Cl. CPC B06B 1/0238; B06B 1/0215

(57) ABSTRACT

A driving signal generation method for generating at least one burst train signal is implemented by a signal generator of an ultrasonic generator system, and includes steps of: receiving a burst signal parameter set that includes at least one single-cycle waveform parameter value and a burst signal count value; determining a single-cycle waveform based on the single-cycle waveform parameter value; outputting the single-cycle waveform repeatedly in a continuous manner; stopping output of the single-cycle waveform for a predetermined time length after the step of outputting the single-cycle waveform repeatedly in the continuous manner; and repeating the steps of outputting the single-cycle waveform repeatedly in the continuous manner and stopping output of the single-cycle waveform for the predetermined time length until a total number of times where the steps of outputting the single-cycle waveform repeatedly and stopping output of the single-cycle waveform is equal to the burst signal count value.

### CROSS-REFERENCE TO RELATED APPLICATION

This application claims priority to Taiwanese Invention patent application No. 113141464, filed on Oct. 30, 2024, the entire disclosure of which is incorporated by reference herein.

### FIELD

The disclosure relates to a driving signal generation method for generating at least one burst train signal, and an ultrasonic generator system for generating various types of ultrasonic beams.

### BACKGROUND

Focus ultrasound (FUS) therapy has garnered widespread attention due to its non-invasive nature and exceptional clinical outcomes. With continuous advancements and improvements in FUS technology, conventional ultrasonic generator systems with multiple channels now offer adjustable focal depths, flexible focal positions, and an ability to alter focusing patterns, enabling them to meet various therapeutic needs, and making them a key area of research. However, as the number of channels in the conventional ultrasonic generator systems continues to increase, the cost and size of the conventional ultrasonic generator systems also grow significantly.

### SUMMARY

Therefore, an object of the disclosure is to provide a driving signal generation method and an ultrasonic generator system that can alleviate at least one of the drawbacks of the prior art.

According to an aspect of the disclosure, the driving signal generation method for generating at least one burst train signal is implemented by a signal generator of an ultrasonic generator system. The driving signal generation method includes steps of: receiving a burst signal parameter set that includes at least one single-cycle waveform parameter value and a burst signal count value; determining a single-cycle waveform based on a plurality of data points that are sequential in time, a number of the data points being equal to the at least one single-cycle waveform parameter value, any two adjacent ones of the data points being distanced apart by a first predetermined time length; outputting the single-cycle waveform repeatedly in a continuous manner; stopping output of the single-cycle waveform for a second predetermined time length after the step of outputting of the single-cycle waveform repeatedly in the continuous manner; and repeating the steps of outputting the single-cycle waveform repeatedly in the continuous manner and stopping output of the single-cycle waveform for the second predetermined time length until a total number of times where the steps of outputting the single-cycle waveform repeatedly in the continuous manner and stopping output of the single-cycle waveform for the second predetermined time length are performed is equal to the burst signal count value, thereby generating the at least one burst train signal.

According to another aspect of the disclosure, the ultrasonic generator system for generating various types of ultrasonic beams includes a signal generator, a driving circuit module, and an ultrasonic transducer. The signal generator is configured to receive a burst signal parameter set and to generate a plurality of burst train signals based on the burst signal parameter set. The driving circuit module is electrically connected to the signal generator for receiving the burst train signals therefrom, and is configured to convert the burst train signals into a plurality of burst train driving signals, respectively. The ultrasonic transducer is electrically connected to the driving circuit module for receiving the burst train driving signals therefrom, and includes a plurality of ultrasonic output surfaces. The ultrasonic transducer is configured to convert the burst train driving signals respectively into a plurality of ultrasonic beams, and to output the ultrasonic beams respectively through the ultrasonic output surfaces. The burst signal parameter set includes at least one single-cycle waveform parameter value and a burst signal count value. The signal generator is further configured to perform the driving signal generation method as mentioned above to generate each of the burst train signals.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram of an ultrasonic generator system according to an embodiment of the present disclosure.

FIG. 2 is a waveform diagram illustrating a burst train signal that is generated by a signal generator of an embodiment of the present disclosure.

FIG. 3 is a flow chart illustrating a first signal generation procedure when the signal generator is operating in a multi-phase burst mode.

FIG. 4 is a schematic diagram of a signal amplifier circuit of a driving circuit module according to an embodiment of the present disclosure.

FIG. 5 is a perspective diagram illustrating an ultrasonic transducer according to an embodiment of the present disclosure.

FIG. 6 is a perspective diagram illustrating a variation of the ultrasonic transducer according to an embodiment of the present disclosure.

FIG. 7 are acoustic pressure distribution maps illustrating acoustic pressure characteristics respectively formed by various types of ultrasonic beams generated by the ultrasonic generator system when the signal generator is operating in the multi-phase burst mode.

FIG. 8 is a flow chart illustrating a second signal generation procedure when the signal generator is operating in a multi-frequency burst mode.

FIG. 9 are acoustic pressure distribution maps illustrating acoustic pressure characteristics respectively formed by various types of ultrasonic beams generated by the ultrasonic generator system when the signal generator is operating in the multi-frequency burst mode.

FIG. 10 is a flow chart illustrating a third signal generation procedure when the signal generator is operating in a chirp mode.

FIG. 11 are waveform diagrams illustrating an example of a plurality of burst train signals generated by the signal generator when the signal generator is operating in the multi-phase burst mode.

FIG. 12 are waveform diagrams illustrating an example of the burst train signals generated by the signal generator when the signal generator is operating in the multi-frequency burst mode.

FIG. 13 are waveform diagrams illustrating an example of the burst train signals that have been processed using a Tukey envelope function.

FIG. 14 are waveform diagrams illustrating an example of the burst train signals generated by the signal generator when the signal generator is operating in the chirp mode.

FIG. 15 is a flow chart illustrating a fourth signal generation procedure when the signal generator is operating in the chirp mode of another type.

FIG. 16 are waveform diagrams illustrating an example of the burst train signals generated by the signal generator performing the fourth signal generation procedure in FIG. 15.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

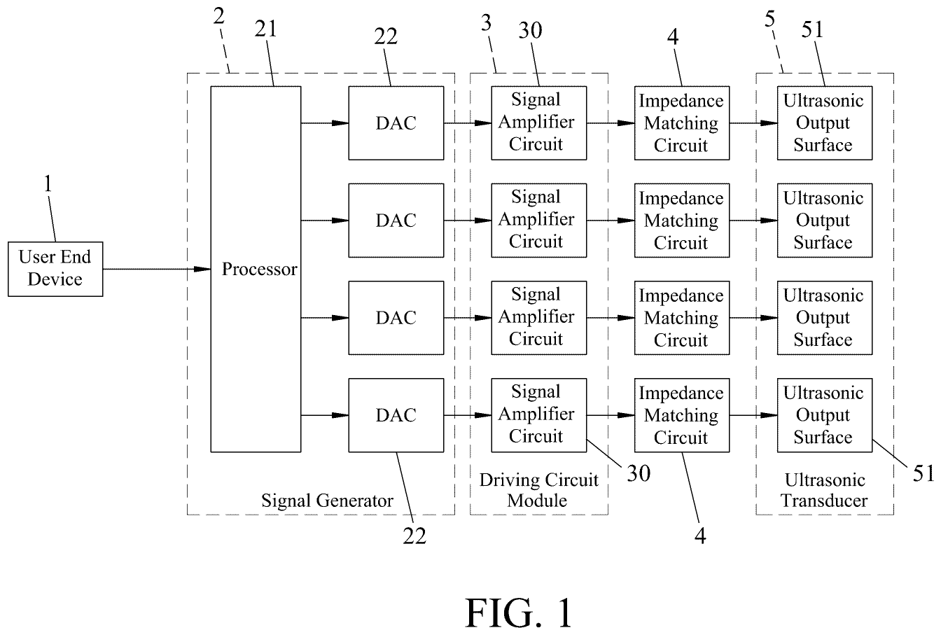

Referring to FIG. 1, an ultrasonic generator system according to an embodiment of the present disclosure is presented and is used for generating various types of ultrasonic beams. The ultrasonic generator system includes a user end device 1, a signal generator 2, a driving circuit module 3, a plurality of impedance matching circuits 4, and an ultrasonic transducer 5.

The user end device 1 is employed for operation by a user to generate a mode selection signal, a burst signal parameter set, and a start signal. The mode selection signal is related to operating modes of the signal generator 2. In this embodiment, the mode selection signal instructs the signal generator 2 to operate in a multi-phase burst mode, a multi-frequency burst mode, or a chirp mode. The user end device 1 is exemplified by a computing device. For example, the user end device 1 may be exemplified as a desktop computer, a notebook computer, a tablet, a smart phone, or an input-output device that is specifically designed for the ultrasonic generator system of this disclosure, but the user end device 1 is not limited to these examples.

The signal generator 2 is electrically connected to the user end device 1 to receive the mode selection signal, the burst signal parameter set, and the start signal therefrom, and may selectively operate in the multi-phase burst mode, the multi-frequency burst mode or the chirp mode according to the mode selection signal thus received. The signal generator 2 is configured to receive the burst signal parameter set and to generate a plurality of burst train signals based on the burst signal parameter set.

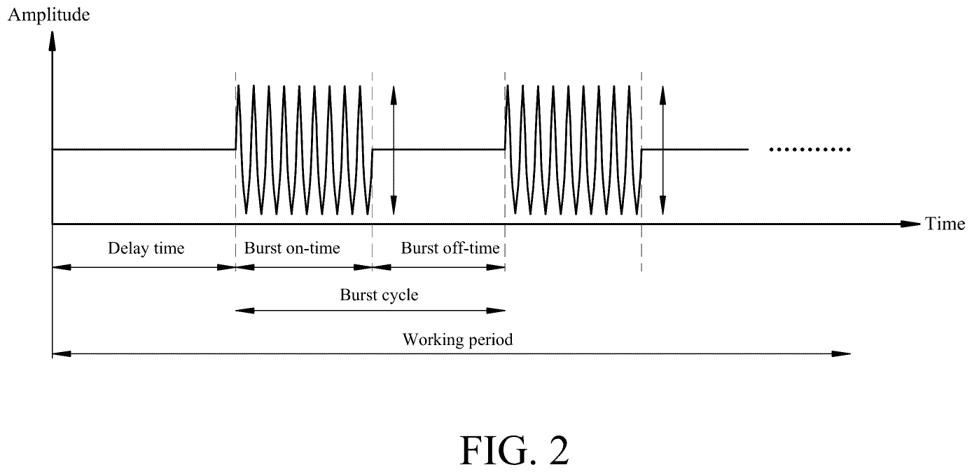

When the user selects the multi-phase burst mode, the user end device 1 generates the mode selection signal that instructs the signal generator 2 to operate in the multi-phase burst mode, and the user inputs a plurality of multi-phase-related values through the user end device 1 for the signal generator 2 to generate the burst signal parameter set that includes a single-cycle waveform parameter value, a plurality of delay parameter values, a waveform count value, and a burst signal count value. In the multi-phase burst mode, at least two of the delay parameter values inputted by the user are of different values. When the signal generator 2 is instructed to operate in the multi-phase burst mode, the signal generator 2 performs a driving signal generation method that is related to the multi-phase burst mode (hereinafter referred to as “the first signal generation procedure”) to generate the burst train signals that correspond respectively to the delay parameter values. According to this disclosure, the ultrasonic generator system has a plurality of channels, and each of the burst train signals corresponds to a respective one of the channels. In this embodiment, the ultrasonic generator system has four channels, but this disclosure is not limited to such. Further referring to FIG. 2, according to this disclosure, each of the burst train signals includes a plurality of burst cycles, and each of the burst cycles is formed with a burst on-time, and a burst off-time. When the signal generator 2 is operating in the multi-phase burst mode, for each of the burst train signals, the signal generator 2 generates the burst train signal after a delay time has elapsed from a start time that is related to the start signal, and a length of the delay time is positively correlated or proportional to a respective one of the delay parameter values.

According to this disclosure, each burst on-time of each of the burst train signals includes a plurality of single-cycle waveforms that are outputted by the signal generator 2 in a continuous manner, and a number of the single-cycle waveforms that are outputted in each burst on-time is equal to the waveform count value of the burst signal parameter set. The burst off-time follows directly after the burst on-time, and has a first predetermined time length. During the burst off-time, the signal generator 2 stops outputting the single-cycle waveforms.

In this embodiment, the signal generator 2 includes a processor 21. The processor 21 determines a single-cycle waveform based on a plurality of data points that are sequential in time, where any two adjacent ones of the data points are distanced apart by a second predetermined time length (e.g., a clock-cycle of the processor 21), and a number of the data points is equal to the single-cycle waveform parameter value included in the burst signal parameter set. In some embodiments, for each of the burst cycles, the signal generator 2 determines whether output of the burst cycle is complete based on a target number of the data points in the burst cycle. The target number of the data points in the burst cycle is equal to a sum of a total number of the data points in the burst on-time (i.e., multiplying the single-cycle waveform parameter value with the waveform count value) and a total number of the data points in the burst off-time. For each of the burst train signals, the burst train signal is generated in a working period, and the signal generator 2 determines whether output of the burst train signal is complete based on a target total number of the data points that corresponds to the working period. The target total number of the data points in the working period is equal to the target number of the data points in the burst cycle multiplied by the burst signal count value.

The processor 21 is exemplified by, for example, but is not limited to, a central processor, a microprocessor, a microcontroller, a field programmable gate array (FPGA), or a complex programmable logic device (CPLD). In this embodiment, the processor 21 of the signal generator 2 is exemplified as the FPGA. The signal generator 2 further includes a plurality of digital-to-analog converters (DACs) 22 that are electrically connected to the processor 21. In this embodiment, the number of the DACs 22 is four. The DACs 22 convert the burst train signals that are generated by the processor 21 and that are digital signals into analog signals. The processor 21 is further electrically connected to the user end device 1 to receive the burst signal parameter set. The processor 21 is electrically connected to the user end device 1 through, for example, an interface in compliance with Universal Serial Bus 3.0 (USB 3.0), but this disclosure is not limited in this respect to this example.

The following illustrates steps taken by the signal generator 2 to generate the burst train signals.

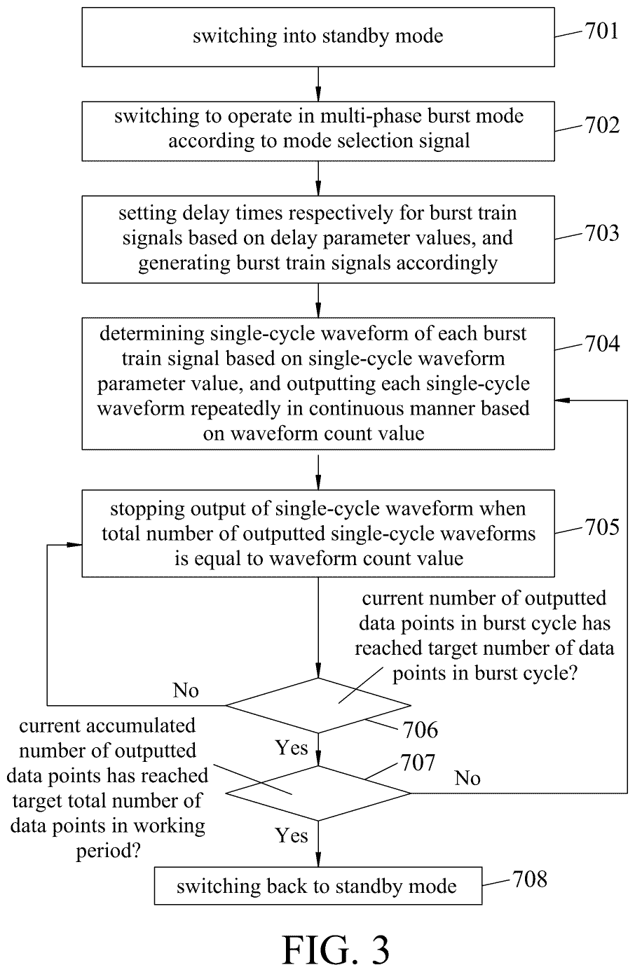

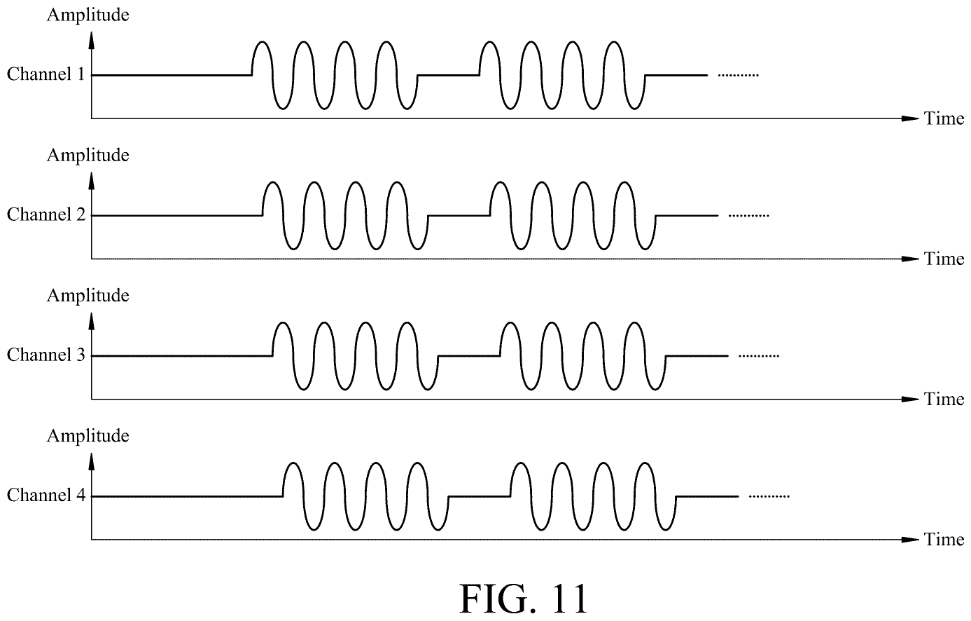

Referring to FIGS. 1 and 3, the first signal generation procedure mentioned above includes steps 701 to 708. Before performing the step 701, the user end device 1 transmits the mode selection signal that instructs the signal generator 2 to operate in the multi-phase burst mode and the burst signal parameter set to the signal generator 2. An example of the burst train signals generated by the signal generator 2 when the signal generator 2 is operating in the multi-phase burst mode is shown in FIG. 11.

In step 701, the signal generator 2 receives and stores the burst signal parameter set, and switches to a standby mode to wait for the start signal from the user end device 1.

In step 702, when the signal generator 2 receives the start signal from the user end device 1, the signal generator 2 switches to operate in the multi-phase burst mode from the standby mode according to the mode selection signal that instructs the signal generator 2 to operate in the multi-phase burst mode.

In step 703, the signal generator 2 sets the delay times respectively for the burst train signals based respectively on the delay parameter values included in the burst signal parameter set, and for each of the burst train signals, the signal generator 2 generates the burst train signal after the delay time that was set, thereby making the single-cycle waveforms of the burst train signals have different starting times which results in phase differences among the burst train signals.

In step 704, for each of the burst cycles of each of the burst train signals, the signal generator 2 determines the single-cycle waveform of the burst train signal based on the single-cycle waveform parameter value, and outputs the single-cycle waveform repeatedly in the continuous manner, in order to output single-cycle waveforms that are continuous in manner based on the waveform count value. Specifically, the number of the single-cycle waveforms to be continuously outputted is equal to the waveform count value.

In step 705, for each of the burst cycles of each of the burst train signals, when a total number of the single-cycle waveforms outputted by the signal generator 2 is equal to the waveform count value, the signal generator 2 stops outputting the single-cycle waveform.

In step 706, for each of the burst cycles of each of the burst train signals, the signal generator 2 determines whether a current number of the data points outputted in the burst cycle (i.e., the number of the data points in the burst cycle accumulated from the start of step 704 in this instance to this point in time) has reached the target number of the data points in the burst cycle, and if the determination is affirmative, which indicates that a length of time the signal generator 2 has stopped output of the single-cycle waveform has reached the first predetermined time length, the flow goes to step 707. The flow returns to step 705 if the determination is otherwise.

In step 707, for each of the burst train signals, the signal generator 2 determines whether a current accumulated number of the data points outputted (i.e., the number of the data points accumulated from the first time the step 704 that was performed up to this point in time) has reached the target total number of the data points in the working period, and if the determination is affirmative, the flow goes to step 708. The flow goes to step 704 if otherwise

In step 708, the signal generator 2 switches to the standby mode again.

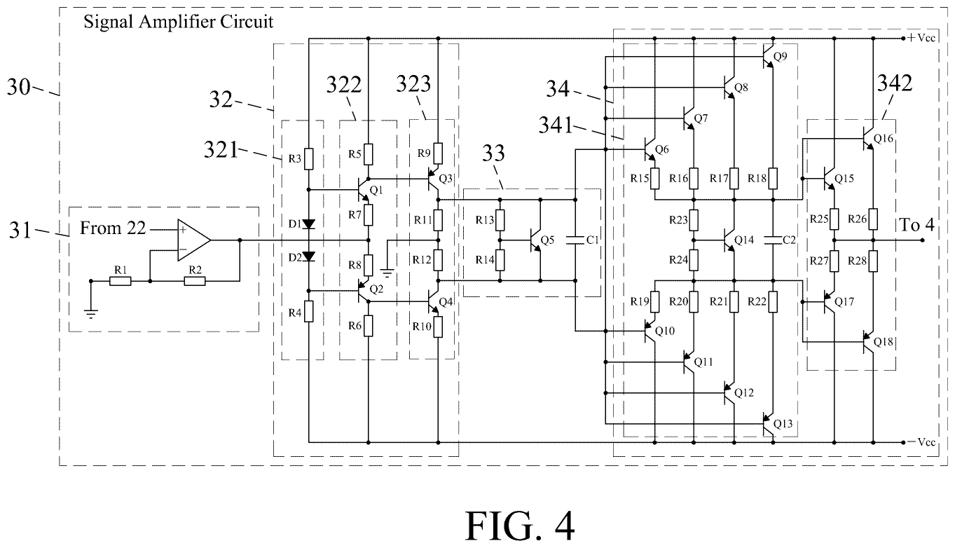

Referring to FIGS. 1 and 4, the driving circuit module 3 is electrically connected to the signal generator 2 for receiving the burst train signals therefrom. The driving circuit module 3 then converts the burst train signals respectively into burst train driving signals. In this embodiment, the driving circuit module 3 includes a plurality of signal amplifier circuits 30 that correspond respectively to the burst train signals. Each of the signal amplifier circuits 30 includes a non-inverting amplifier 31, a voltage amplifier circuit 32, a coupling circuit 33, and a current amplifier circuit 34.

For each of the signal amplifier circuits 30, the non-inverting amplifier 31 includes an operational amplifier, and resistors (R1, R2). The operational amplifier has an inverting input terminal, a non-inverting input terminal electrically connected to a respective one of the DACs 22 of the signal generator 2, and an output terminal. The resistor (R1) has a terminal electrically connected to the inverting input terminal of the operational amplifier, and another terminal connected to a system ground. The resistor (R2) has a terminal electrically connected to the inverting input terminal of the operational amplifier, and another terminal electrically connected to the output terminal of the operational amplifier. The non-inverting amplifier 31 receives the corresponding one of the burst train signals generated by the respective one of the DACs 22, and performs voltage amplification on the corresponding one of the burst train signals thus received in order to generate a first amplified signal.

The voltage amplifier circuit 32 includes a biasing circuit 321, a common base amplifier 322, and a common emitter amplifier 323. The biasing circuit 321 includes diodes (D1, D2) and resistors (R3, R4). The diode (D1) has a first terminal and a second terminal. The diode (D2) has a first terminal, and a second terminal that is electrically connected to the first terminal of the diode (D1). The resistor (R3) has a first terminal electrically connected to the second terminal of the diode (D1), and a second terminal that is electrically connected to a positive power supply (+Vcc). The resistor (R4) has a first terminal electrically connected to the first terminal of the diode (D2), and a second terminal electrically connected to a negative power supply (−Vcc).

The common base amplifier 322 includes transistors (Q1, Q2) and resistors (R5, R6, R7, R8). The transistor (Q1) has a first terminal electrically connected to the second terminal of the diode (D1) and the first terminal of the resistor (R3), a second terminal and a third terminal. The transistor (Q2) has a first terminal electrically connected to the first terminal of the diode (D2) and the first terminal of the resistor (R4), a second terminal and a third terminal. The resistor (R5) has a first terminal electrically connected to the second terminal of the transistor (Q1), and a second terminal electrically connected to the positive power supply (+Vcc). The resistor (R6) has a first terminal electrically connected to the third terminal of the transistor (Q2), and a second terminal electrically connected to the negative power supply (−Vcc). The resistor (R7) has a first terminal electrically connected to the third terminal of the transistor (Q1), and a second terminal electrically connected to the output terminal of the operational amplifier of the non-inverting amplifier 31. The resistor (R8) has a first terminal electrically connected to the second terminal of the transistor (Q2), and a second terminal electrically connected to the output terminal of the operational amplifier of the non-inverting amplifier 31.

The common emitter amplifier 323 includes transistors (Q3, Q4) and resistors (R9, R10, R11, R12). The transistor (Q3) has a first terminal electrically connected to the second terminal of the transistor (Q1) and the first terminal of the resistor (R5), a second terminal and a third terminal. The transistor (Q4) has a first terminal electrically connected to the third terminal of the transistor (Q2) and the first terminal of the resistor (R6), a second terminal and a third terminal. The resistor (R9) has a first terminal electrically connected to the second terminal of the transistor (Q3), and a second terminal electrically connected to the positive power supply (+Vcc). The resistor (R10) has a first terminal electrically connected to the third terminal of the transistor (Q4), and a second terminal electrically connected to the negative power supply (−Vcc). The resistor (R11) has a first terminal electrically connected to the third terminal of the transistor (Q3), and a second terminal connected to the system ground. The resistor (R12) has a first terminal electrically connected to the second terminal of the transistor (Q4), and a second terminal connected to the system ground.

In this embodiment, the voltage amplifier circuit 32 is designed with an up-down symmetric structure that amplifies voltages respectively of a positive half-cycle signal and a negative half-cycle signal of the first amplified signal. The biasing circuit 321 provides the common base amplifier 322 with a direct current (DC) bias voltage that causes operating voltages of the transistors (Q1, Q2) to be in an active region. The common base amplifier 322 is employed to improve a bandwidth of high-frequency response. The common emitter amplifier 323 receives the first amplified signal through the common base amplifier 322, and applies linear voltage amplification to the positive half-cycle signal and the negative half-cycle signal of the first amplified signal to generate an amplified positive half-cycle signal and an amplified negative half-cycle signal.

The coupling circuit 33 includes resistors (R13, R14), a transistor (Q5), and a capacitor (C1). The resistor (R13) has a first terminal electrically connected to the third terminal of the transistor (Q3) and the first terminal of the resistor (R11), and a second terminal. The resistor (R14) has a first terminal electrically connected to the second terminal of the transistor (Q4) and the first terminal of the resistor (R12), and a second terminal. The transistor (Q5) has a first terminal electrically connected to the second terminal of the resistor (R13) and the second terminal of the resistor (R14), a second terminal electrically connected to the first terminal of the resistor (R13), and a third terminal electrically connected to the first terminal of the resistor (R14). The capacitor (C1) has a first terminal electrically connected to the second terminal of the transistor (Q5), and a second terminal electrically connected to the third terminal of the transistor (Q5).

The coupling circuit 33 receives the amplified positive half-cycle signal and the amplified negative half-cycle signal from the voltage amplifier circuit 32, merges the amplified positive half-cycle signal and the amplified negative half-cycle signal into a second amplified signal, and transmits the second amplified signal to the current amplifier circuit 34.

The current amplifier circuit 34 includes a first common collector amplifier 341 and a second common collector amplifier 342. The first common collector amplifier 341 includes transistors (Q6 to Q14), resistors (R15 to R24), and a capacitor (C2). The transistors (Q6 to Q9) each have a first terminal electrically connected to the first terminal of the capacitor (C1) of the coupling circuit 33, a second terminal electrically connected to the positive power supply (+Vcc), and a third terminal. The resistors (R15 to R18) each have a first terminal that is electrically connected to a respective one of the third terminals respectively of the transistors (Q6 to Q9), and a second terminal. The transistors (Q10 to Q13) each have a first terminal electrically connected to the second terminal of the capacitor (C1) of the coupling circuit 33, a second terminal electrically connected to the negative power supply (−Vcc), and a third terminal. The resistors (R19 to R22) each have a first terminal that is electrically connected to a respective one of the third terminals respectively of the transistors (Q10 to Q13), and a second terminal.

The resistor (R23) has a first terminal electrically connected to the second terminals respectively of sixth resistors (R15 to R18), and a second terminal.

The resistor (R24) has a first terminal electrically connected to the second terminals respectively of the resistors (R19 to R22), and a second terminal electrically connected to the second terminal of the resistor (R23).

The transistor (Q14) has a first terminal electrically connected to the second terminals of the resistors (R23, R24), a second terminal electrically connected to the first terminal of the resistor (R23), and a third terminal electrically connected to the first terminal of the resistor (R24). The capacitor (C2) has a first terminal electrically connected to the second terminal of the transistor (Q14), and a second terminal electrically connected to the third terminal of the transistor (Q14).

The second common collector amplifier 342 includes transistors (Q15 to Q18) and resistors (R25 to R28). The transistors (Q15, Q16) each have a first terminal electrically connected to the second terminal of the fourth transistor (Q14) of the first common collector amplifier 341, a second terminal electrically connected to the positive power supply (+Vcc), and a third terminal. The resistors (R25, R26) each have a first terminal electrically connected respectively to the third terminals respectively of the transistors (Q15, Q16), and a second terminal. The transistors (Q17, Q18) each have a first terminal electrically connected to the third terminal of the transistor (Q14) of the first common collector amplifier 341, a second terminal electrically connected to the negative power supply (−Vcc), and a third terminal. The resistors (R27, R28) each have a first terminal electrically connected respectively to the third terminals respectively of the transistors (Q17, Q18), and a second terminal. The second terminals respectively of the seventh resistors (R25 to R28) are electrically connected to each other at a common point and the common point serves as an output terminal for the signal amplifier circuit 30.

The current amplifier circuit 34 receives the second amplified signal from the coupling circuit 33, and applies a two-stage current amplification on the second amplified signal through the first common collector amplifier 341 and the second common collector amplifier 342. Specifically, a current of the second amplified signal is amplified to a required level (e.g., from a microampere level to a milliampere level, and then to an ampere level) to generate a burst train driving signal.

In this embodiment, each of the transistors (Q1 to Q18) is exemplified as a bipolar junction transistor (BJT) that has a base, an emitter, and a collector. In other embodiments, each of the transistors (Q1 to Q18) may be exemplified by a metal-oxide-semiconductor field-effect transistor (MOSFET) that has a gate, a source, and a drain. However, the transistors (Q1 to Q18) are not limited to these examples.

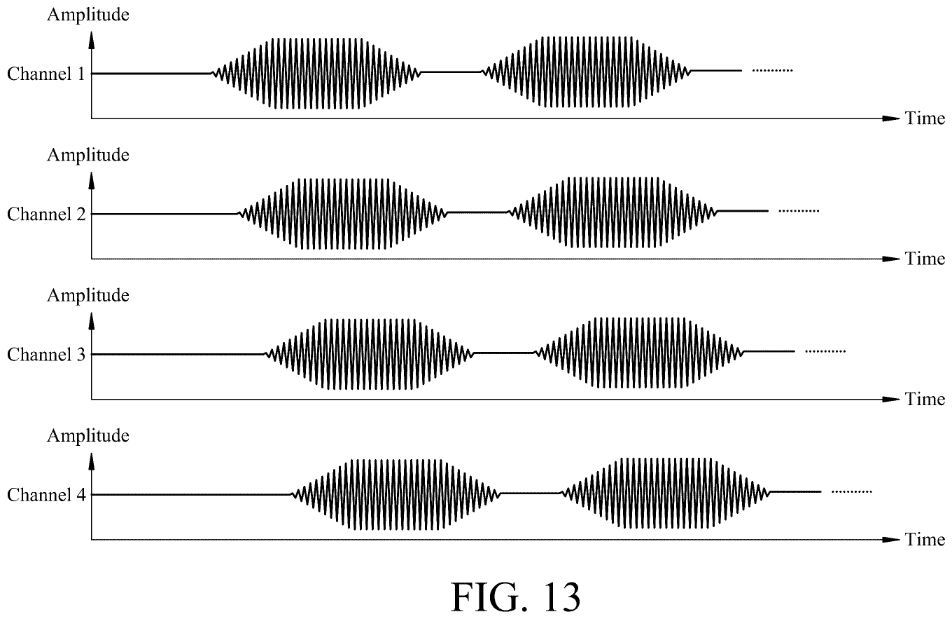

In some embodiments, the driving circuit module 3 may perform signal processing on the burst train driving signals, for example, by applying a Tukey envelope. An example of the burst train driving signals after the Tukey envelope is applied is shown in FIG. 13. By applying the Tukey envelope, a burst waveform (i.e., the single-cycle waveforms that are outputted in the continuous manner within a burst cycle) forms a smooth transition at a beginning and at an end of the burst waveform. The application of the Tukey envelope may reduce side effects of auditory artifacts during brain stimulation, and minimize the likelihood of ultrasound being detected by ears of a subject and causing auditory sensations. Therefore, the application of the Tukey envelope may help prevent misinterpretation of the auditory sensations as direct experimental outcomes, thereby making results of an ultrasound-based neuromodulation more reliable.

The impedance matching circuits 4 are electrically connected respectively to the output terminals of the signal amplifier circuits 30 of the driving circuit module 3 so as to respectively receive the burst train driving signals therefrom. The impedance matching circuits 4 are employed to adjust impedances between the signal amplifier circuits 30 and the ultrasonic transducer 5 so that the burst train driving signals can be effectively inputted to the ultrasonic transducer 5.

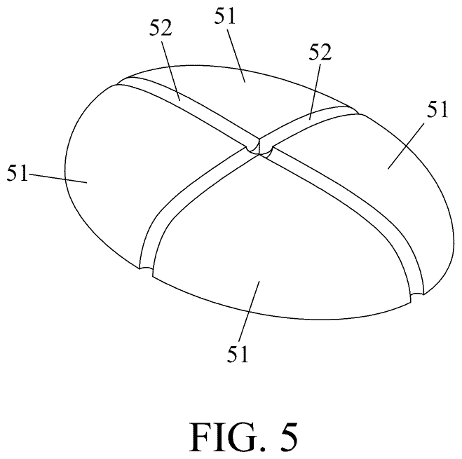

According to the present disclosure, the ultrasonic transducer 5 is electrically connected to the impedance matching circuits 4 for receiving the burst train driving signals therefrom. The ultrasonic transducer 5 includes a plurality of ultrasonic output surfaces 51 that correspond respectively to the burst train driving signals. The ultrasonic transducer 5 converts the burst train driving signals respectively into the ultrasonic beams and outputs the ultrasonic beams respectively through the ultrasonic output surfaces 51. The ultrasonic output surfaces 51 correspond respectively to the channels of the ultrasonic generator system. Referring to FIG. 5, in some embodiments, the ultrasonic transducer 5 further includes a plurality of grooves 52 that extend in straight lines away from a common intersecting point, where any two adjacent ones of the ultrasonic output surfaces 51 are spaced apart by one of the grooves 52, and each of the ultrasonic output surfaces 51 forms a sector. In this embodiment, the ultrasonic transducer 5 includes four ultrasonic output surfaces 51, and the grooves 52 cooperatively form a cross-shaped groove, but this disclosure is not limited to such.

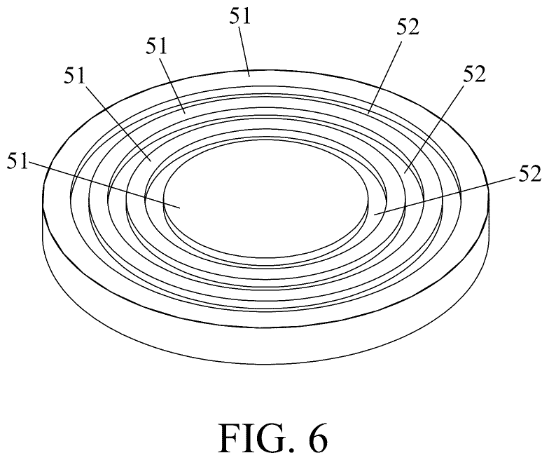

In some other embodiments, the grooves 52 may be circular in shape, and the ultrasonic output surfaces 51 are spaced apart by the grooves 52 that cooperatively form concentric circles. Specifically, any two adjacent ones of the ultrasonic output surfaces 51 are spaced apart by one of the grooves 52, and each of the ultrasonic output surfaces 51 forms a circle or a ring (as shown in FIG. 6, one of the ultrasonic output surfaces 51 that is in the center forms a circular surface and the rest of the ultrasonic output surfaces 51 respectively form ring-shaped surfaces). However, the ultrasonic output surfaces 51 may be divided to form other shapes and are not limited by the examples of this disclosure.

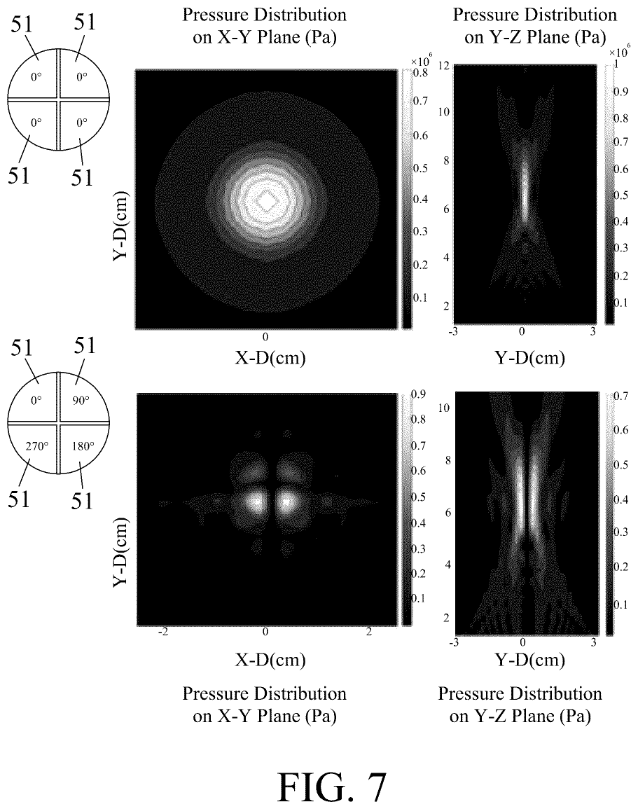

FIG. 7 presents acoustic pressure distribution characteristics formed by the ultrasonic beams generated respectively by the ultrasonic output surfaces 51 of the ultrasonic transducer 5 with a design similar to that of FIG. 5 when the signal generator 2 is operating in the multi-phase burst mode. When a phase difference between the burst train signals is 0 degrees (as shown in the upper ones of the acoustic pressure distribution maps in FIG. 7), an acoustic pressure is maximized at a center of an X-Y plane that corresponds to the ultrasonic output surfaces 51. When the phase difference between the burst train signals is 90 degrees (i.e., the phases of the burst train signals in this embodiment are 0 degrees, 90 degrees, 180 degrees, and 270 degrees, respectively) (as shown in lower ones of the acoustic pressure distribution maps in FIG. 7), the burst train signals with 90 degrees phase difference cover a wider acoustic pressure distribution as compared to the burst train signals with 0 degrees phase difference. Furthermore, the acoustic pressure at the center with respect to the X-Y plane exhibited by the burst train signals with 90 degrees difference is lower than the acoustic pressure at areas around the center of the X-Y plane, thereby exhibiting a characteristic of dynamic focusing.

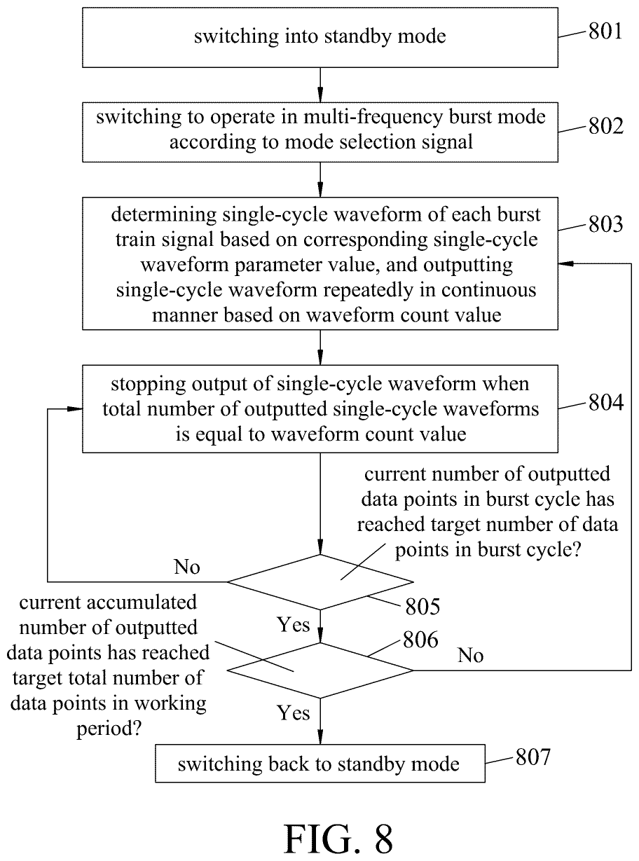

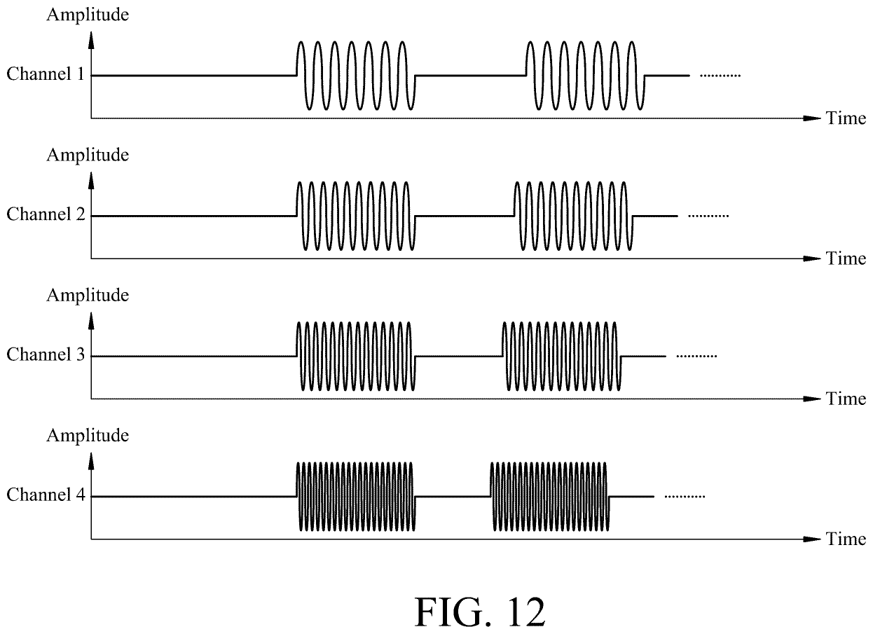

Referring to FIGS. 1 and 8, when the user selects the multi-frequency burst mode, the user end device 1 generates the mode selection signal that instructs the signal generator 2 to operate in the multi-frequency burst mode, and the user inputs a plurality of multi-frequency-related values through the user end device 1 for the signal generator 2 to generate the burst signal parameter set that includes a plurality of single-cycle waveform parameter values, a waveform count value, and a burst signal count value. At least two of the single-cycle waveform parameter values inputted by the user are of different values. When the signal generator 2 is instructed to operate in the multi-frequency burst mode, the signal generator 2 performs a driving signal generation method that is related to the multi-frequency burst mode (hereinafter referred to as “the second signal generation procedure”) to generate the burst train signals that correspond respectively to the single-cycle waveform parameter values. The second signal generation procedure includes steps 801 to 807, where steps 801, and 804 to 807 are similar to the steps 701, and 705 to 708 in FIG. 3, respectively, so descriptions thereof will be omitted for the sake of brevity. An example of the burst train signals generated by the signal generator 2 when the signal generator 2 is operating in the multi-frequency burst mode is shown in FIG. 12.

In step 802, when the signal generator 2 receives the start signal from the user end device 1, the signal generator 2 switches to operate in the multi-frequency burst mode from the standby mode according to the mode selection signal that instructs the signal generator 2 to operate in the multi-frequency burst mode.

In step 803, for each of the burst cycles of each of the burst train signals, the signal generator 2 determines the single-cycle waveform of the burst train signal based on a respective one of the single-cycle waveform parameter values, and outputs the single-cycle waveform repeatedly in the continuous manner based on the waveform count value. Since at least two of the single-cycle waveform parameter values are different, at least two of the burst train signals generated have single-cycle waveforms that are of different frequencies.

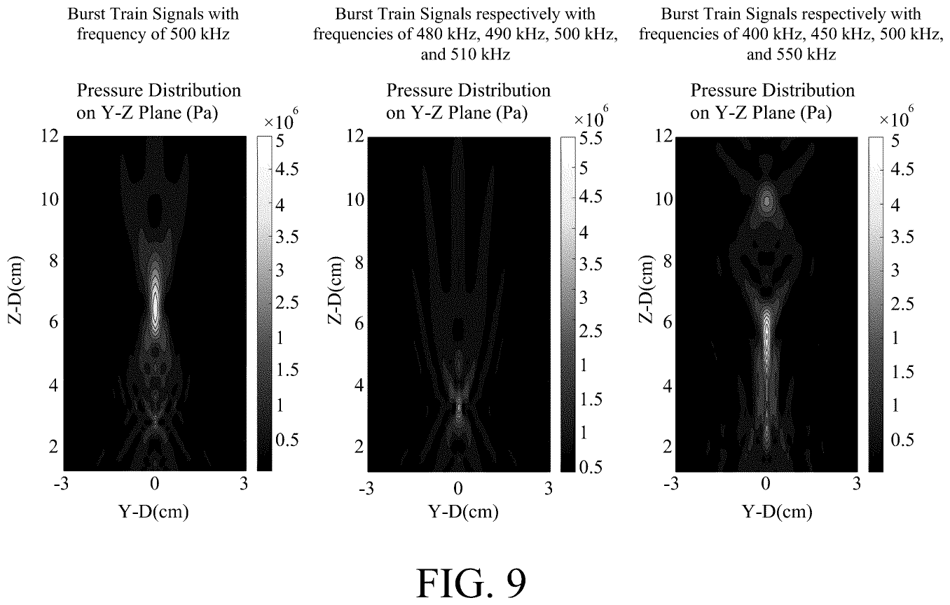

FIG. 9 presents acoustic pressure distribution characteristics formed by the ultrasonic beams generated respectively by the ultrasonic output surfaces 51 of the ultrasonic transducer 5 with a design similar to that of FIG. 6 when the signal generator 2 is operating in the multi-frequency burst mode. It can be seen from FIG. 9 as frequency differences among the single-cycle waveforms of the burst train signals varies (a leftmost one of the acoustic pressure distribution maps the burst train signals with single-cycle waveforms of 0 KHz frequency difference; a center one of the acoustic pressure distribution maps the burst train signals with single-cycle waveforms of 10 KHz frequency difference; and a rightmost one of the acoustic pressure distribution maps the burst train signals with single-cycle waveforms of 50 KHz frequency difference), the resulting acoustic pressure distributions also varies. Due to a multi-frequency nature of these burst train signals, a depth of a focal position of acoustic pressure formed by a constructive interference of the ultrasonic beams, changes with the frequency difference. That is to say, a distribution length along a Z-axis of the focal position, which is formed by the constructive interference of the ultrasonic beams that are outputted respectively through the ultrasonic output surfaces (51) onto a target space, is related to the frequency difference between the ultrasonic beams. Specifically, a larger frequency difference results in a shorter distribution length of the focal position along the Z-axis in the target space.

In some embodiments, the user inputs a plurality of single-cycle waveform parameter values that correspond respectively to the burst train signals, a plurality of delay parameter values that correspond respectively to the burst train signals, a plurality of waveform count values that correspond respectively to the burst train signals, and a plurality of burst signal count values that correspond respectively to the burst train signals to form the burst train signal parameter set in order for the signal generator 2 to generate the burst train signals with different start times or phases and with single-cycle waveforms of different frequencies during the burst on-time. In such embodiments, a procedure by which the signal generator 2 generates the burst train signals based on the burst signal parameter set is similar to the procedures described above and will therefore be omitted for the sake of brevity.

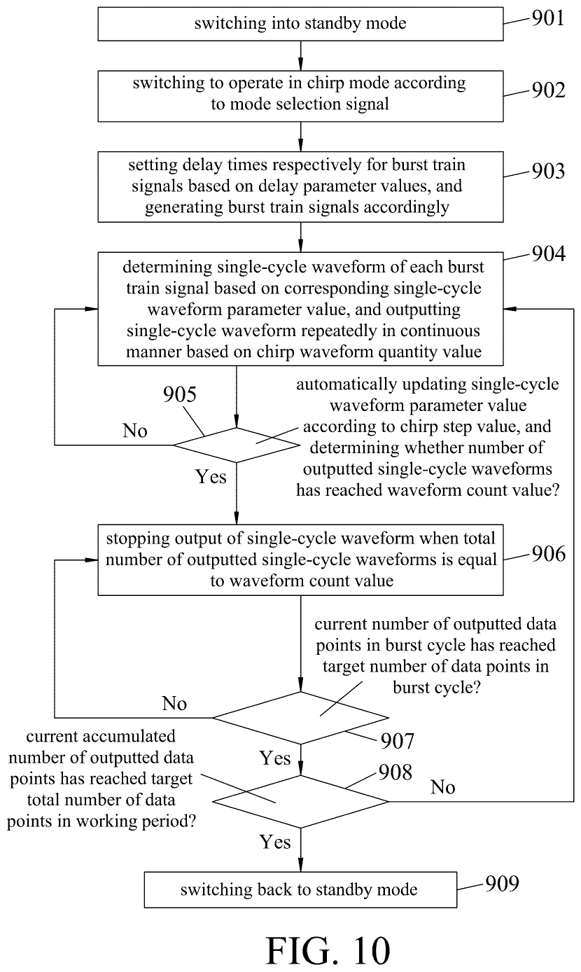

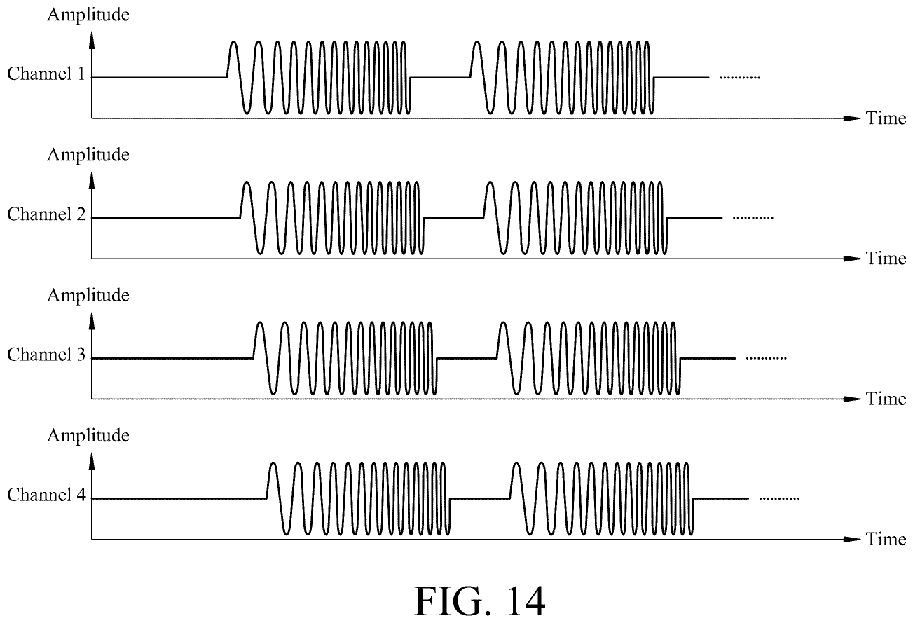

Referring to FIGS. 1 and 10, when the user selects the chirp mode, the user end device 1 generates the mode selection signal that instructs the signal generator 2 to operate in the chirp mode, and the user inputs one or more single-cycle waveform parameter values, one or more delay parameter values, a waveform count value, a burst signal count value, a chirp waveform quantity value, and a chirp step value for the signal generator 2 to generate the burst signal parameter set. When the signal generator 2 is instructed to operate in the chirp mode, the signal generator 2 performs a driving signal generation method that is related to the chirp mode (hereinafter referred to as “the third signal generation procedure”). The third signal generation procedure includes steps 901 to 909, where steps 901, 903, 906, 907 and 909 are respectively similar to the steps 701, 703, 705, 706 and 708 of FIG. 3, so descriptions thereof will be omitted for the sake of brevity. An example of the burst train signals generated by the signal generator 2 when the signal generator 2 is operating in the chirp mode is shown in FIG. 14.

In step 902, when the signal generator 2 receives the start signal from the user end device 1, the signal generator 2 switches to operate in the chirp mode from the standby mode according to the mode selection signal that instructs the signal generator 2 to operate in the chirp mode.

In step 904, for each of the burst cycles of each of the burst train signals, the signal generator 2 determines the single-cycle waveform of the burst train signal based on a respective one of the single-cycle waveform parameter values, where the respective one of the single-cycle waveform parameter values included in the burst signal parameter set is used as a starting value, and the signal generator 2 outputs the single-cycle waveform repeatedly in the continuous manner based on the chirp waveform quantity value.

In step 905, for each of the burst train signals, the signal generator 2 automatically updates the single-cycle waveform parameter value according to the chirp step value (i.e., updating the number of the data points that are used to determine the single-cycle waveform). For example, the single-cycle waveform parameter value may be updated by adding the chirp step value to the single-cycle waveform parameter value that is currently being used to determine the single-cycle waveform. The signal generator 2 then determines whether the number of the single-cycle waveforms that have been outputted has reached the waveform count value. When the determination is affirmative, the flow goes to the step 906; when the determination is negative, the flow goes back to the step 904. When the flow goes back to the step 904, the signal generator 2 re-determines the single-cycle waveform using the single-cycle waveform parameter value that has been updated. Specifically, when the chirp step value is a positive value, the single-cycle waveform parameter value changes incrementally each time step 905 is performed, and consequently, a frequency of the single-cycle waveforms that are generated changes in a decreasing manner; when the chirp step value is a negative value, the single-cycle waveform parameter value changes decrementally each time step 905 is performed, and consequently, the frequency of the single-cycle waveforms that are generated changes in an increasing manner.

In step 908, for each of the burst train signals, the signal generator 2 determines whether the accumulated number of the data points has reached the target total number of the data points in the working period. The flow goes to step 909 when the determination is affirmative. When the determination is negative, the signal generator 2 resets the single-cycle waveform parameter value to the starting value (i.e., the single-cycle waveform parameter value included in the burst signal parameter set), and the flow goes back to step 904.

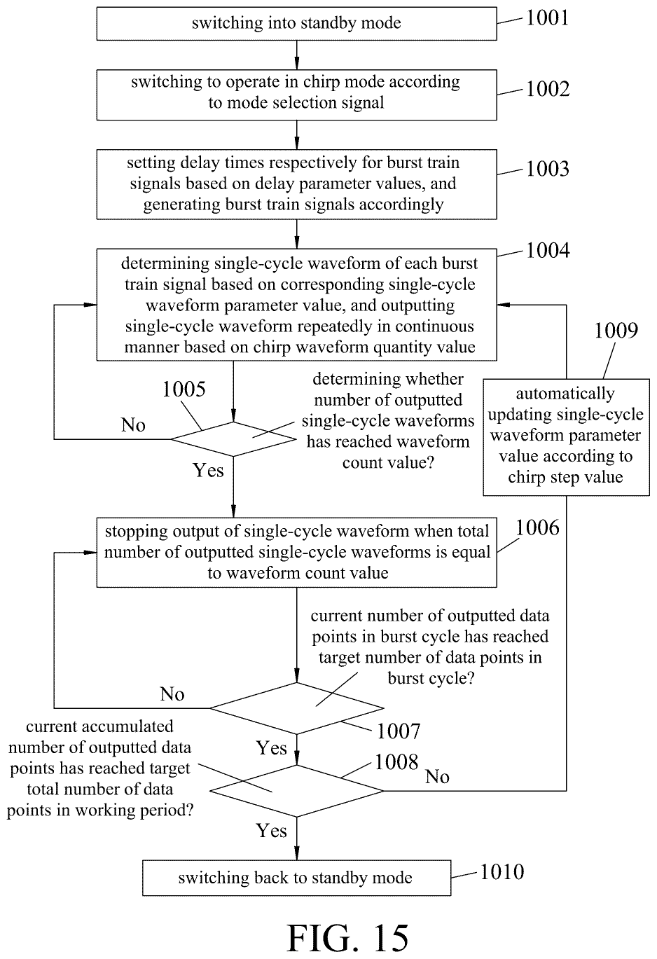

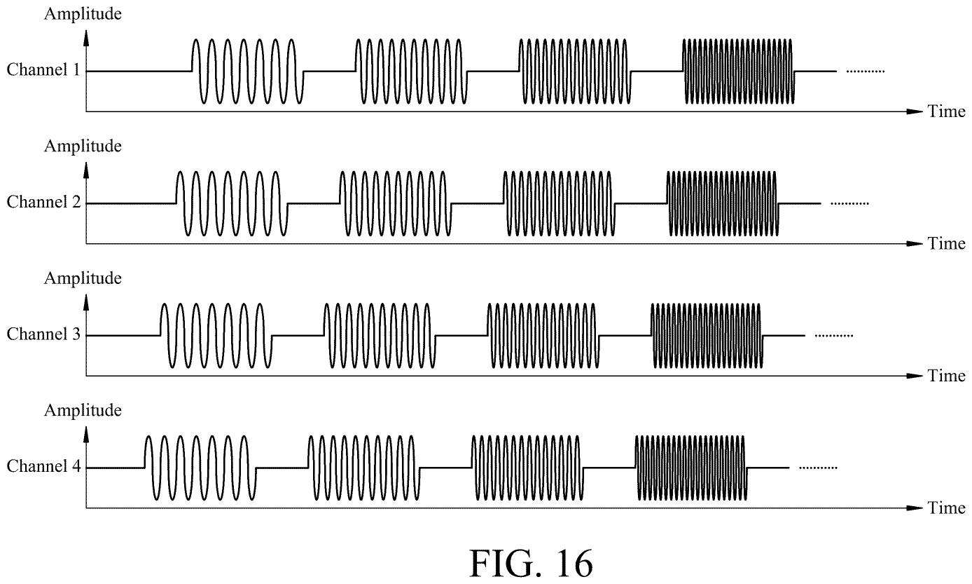

Referring to FIGS. 1 and 15, a variation of the third signal generation procedure (hereinafter referred to as “the fourth signal generation procedure”) where the user selects the chirp mode is presented. The fourth signal generation procedure includes steps 1001 to 1010, where steps 1001 to 1004, 1006, 1007 and 1010 are respectively similar to the steps 901 to 904, 906, 907 and 909 of FIG. 10, so descriptions thereof will be omitted for the sake of brevity. An example of the burst train signals generated by the signal generator 2 according to this variation when the signal generator 2 is operating in the chirp mode is shown in FIG. 16.

In step 1005, for each of the burst train signals, the signal generator 2 determines whether the number of the single-cycle waveforms that have been generated has reached the waveform count value. The flow goes to the step 1006 when the determination is affirmative and goes to the step 1004 when otherwise.

In step 1008, for each of the burst train signals, the signal generator 2 determines whether the total number of the data points (the number of the data points calculated from a first time step 1004 that was performed up to this time) has reached the target total number of the data points in the working period. The flow goes to step 1010 when the determination is affirmative, and goes to step 1009 when otherwise.

In step 1009, for each of the burst train signals, the signal generator 2 automatically updates the single-cycle waveform parameter value according to the chirp step value (i.e., updating the number of the data points that are used to determine the single-cycle waveform). For example, the single-cycle waveform parameter value may be updated by adding the chirp step value to the single-cycle waveform parameter value that is currently being used to determine the single-cycle waveform, and the flow goes back to the step 1004. When the flow goes back to the step 1004, the signal generator 2 re-determines the single-cycle waveform using the single-cycle waveform parameter value that has been updated. Specifically, when the chirp step value is a positive value, the single-cycle waveform parameter value changes incrementally each time the step 1009 is performed, and correspondingly, the frequency of the single-cycle waveforms that are generated changes in the decreasing manner; when the chirp step value is a negative value, the single-cycle waveform parameter value changes decrementally each time the step 1009 is performed, and correspondingly, the frequency of the single-cycle waveforms that are generated changes in the increasing manner.

When the signal generator 2 is operating in the chirp mode, the ultrasonic beams produced by the ultrasonic output surfaces 51 of the ultrasonic transducer 5 change according to changes in the frequencies of the burst train signals. Continuous frequency dynamics of these ultrasonic beams over a period of time combine to produce varying acoustic pressures within that period of time. This characteristic can facilitate an application of microbubbles in ultrasonic therapy, and thereby enhancing the permeability of the blood-brain barrier, for example, or improving the effectiveness of ultrasonic treatments.

In summary, the signal generator 2 of this disclosure is able to generate the burst train signals, and the single-cycle waveforms of the burst train signals are able to be outputted at different frequencies and/or phases. The driving circuit module 3 applies linear voltage and current amplification to the burst train signals, which enables the ultrasonic beams emitted from the ultrasonic output surfaces 51 of the ultrasonic transducer 5 to cooperatively produce multiple focal depths and positions. By virtue of the above arrangements, the ultrasonic generator system of this disclosure is capable of adjusting the burst train signals generated respectively by the channels of the ultrasonic generator system using multiple parameters. This allows the ultrasonic generator system to output ultrasonic beams that collectively produce different focal depths and positions. Therefore, the ultrasonic generator system of this disclosure is able to provide adjustable focal depths, flexible focal positions, and an ability to alter focusing patterns, thereby allowing it to cater to a wide range of ultrasonic therapy applications.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A driving signal generation method for generating at least one burst train signal, said driving signal generation method being implemented by a signal generator of an ultrasonic generator system, and comprising steps of:
receiving a burst signal parameter set that includes at least one single-cycle waveform parameter value and a burst signal count value;
determining a single-cycle waveform based on a plurality of data points that are sequential in time, a number of the plurality of data points being equal to the at least one single-cycle waveform parameter value, any two adjacent ones of the plurality of data points being distanced apart by a first predetermined time length;
outputting the single-cycle waveform repeatedly in a continuous manner;
stopping output of the single-cycle waveform for a second predetermined time length after the step of outputting the single-cycle waveform repeatedly in the continuous manner; and
repeating the steps of outputting the single-cycle waveform repeatedly in the continuous manner and stopping output of the single-cycle waveform for the second predetermined time length until a total number of times where the steps of outputting the single-cycle waveform repeatedly in the continuous manner and stopping output of the single-cycle waveform for the second predetermined time length are performed is equal to the burst signal count value, thereby generating the at least one burst train signal.

2. The driving signal generation method as claimed in claim 1, wherein the burst signal parameter set further includes a waveform count value, and the single-cycle waveform is outputted for a number of times equal to the waveform count value when the signal generator is outputting the single-cycle waveform repeatedly in the continuous manner.

3. The driving signal generation method as claimed in claim 1, wherein the at least one burst train signal includes a plurality of burst train signals,
wherein the burst signal parameter set further includes a plurality of delay parameter values that correspond respectively to the plurality of burst train signals; and
wherein for each of the plurality of burst train signals, the signal generator generates the burst train signal after a delay time, and a length of the delay time is positively correlated to the respective one of the plurality of delay parameter values.

4. The driving signal generation method as claimed in claim 1, wherein the at least one burst train signal includes a plurality of burst train signals,
wherein the at least one single-cycle waveform parameter value includes a plurality of single-cycle waveform parameter values that correspond respectively to the plurality of burst train signals; and
wherein for each of the plurality of burst train signals, the number of the plurality of data points that are used by the signal generator to determine the single-cycle waveform is equal to the respective one of the plurality of single-cycle waveform parameter values.

5. The driving signal generation method as claimed in claim 1, further comprising a step of
automatically updating the number of the plurality of data points and re-determining the single-cycle waveform based on the plurality of data points that have been updated when the signal generator is outputting the single-cycle waveform repeatedly in the continuous manner.

6. The driving signal generation method as claimed in claim 1, further comprising a step of,
after the signal generator outputs the single-cycle waveform repeatedly in the continuous manner, and before the signal generator repeats the steps of outputting the single-cycle waveform repeatedly in the continuous manner and stopping output of the single-cycle waveform for the second predetermined time length, automatically updating the number of the plurality of data points and re-determining the single-cycle waveform based on the plurality of data points that have been updated.

7. The driving signal generation method as claimed in claim 1, wherein the at least one burst train signal includes a plurality of burst train signals, and the signal generator selectively operates in one of a multi-phase burst mode, a multi-frequency burst mode, and a chirp mode,
wherein when the signal generator is operating in the multi-phase burst mode, the burst signal parameter set further includes a plurality of delay parameter values that are unique and that correspond respectively to the plurality of burst train signals, and for each of the plurality of burst train signals, the signal generator generates the burst train signal after a delay time based on the respective one of the plurality of delay parameter values, thereby making the single-cycle waveforms of the plurality of burst train signals have different starting times;
wherein when the signal generator is operating in the multi-frequency burst mode, the at least one single-cycle waveform parameter value includes a plurality of single-cycle waveform parameter values that are unique and that correspond respectively to the plurality of burst train signals, and for each of the plurality of burst train signals, the signal generator determines the single-cycle waveform according to the respective one of the plurality of single-cycle waveform parameter values; and
wherein when the signal generator is operating in the chirp mode, for each of the plurality of burst train signals, the signal generator automatically updates a corresponding one of the at least one single-cycle waveform parameter value in one of an incremental and a decremental manner, so that the number of the plurality of data points that are used to determine the single-cycle waveform are updated in one of the incremental and the decremental manner.

8. An ultrasonic generator system for generating various types of ultrasonic beams, comprising:
a signal generator configured to receive a burst signal parameter set and to generate a plurality of burst train signals based on the burst signal parameter set;
a driving circuit module electrically connected to said signal generator for receiving the plurality of burst train signals therefrom, and configured to convert the plurality of burst train signals into a plurality of burst train driving signals, respectively; and
an ultrasonic transducer electrically connected to said driving circuit module for receiving the plurality of burst train driving signals therefrom, including a plurality of ultrasonic output surfaces, and configured to convert the plurality of burst train driving signals respectively into a plurality of ultrasonic beams and to output the plurality of ultrasonic beams respectively through said plurality of ultrasonic output surfaces,
wherein the burst signal parameter set includes at least one single-cycle waveform parameter value and a burst signal count value,
wherein said signal generator is further configured to perform a method as claimed in claim 1 to generate each of the plurality of burst train signals.

9. The ultrasonic generator system as claimed in claim 8, wherein said ultrasonic transducer further includes a plurality of grooves extending in straight lines away from a common intersecting point, any two adjacent ones of said plurality of ultrasonic output surfaces are spaced apart by one of said plurality of grooves, and each of said ultrasonic output surfaces forms a sector.

10. The ultrasonic generator system as claimed in claim 8, wherein said driving circuit module includes a plurality of signal amplifier circuits that respectively correspond to the plurality of burst train signals, and each of said plurality of signal amplifier circuits includes
a non-inverting amplifier electrically connected to said signal generator for receiving the corresponding one of the plurality of burst train signals therefrom, and configured to perform voltage amplification on the corresponding one of the plurality of burst train signals thus received in order to generate a first amplified signal,
a voltage amplifier circuit having a common base amplifier that is electrically connected to said non-inverting amplifier, and a common emitter amplifier that is electrically connected to said common base amplifier, said common emitter amplifier being configured to receive the first amplified signal from said common base amplifier and to perform linear voltage amplification on the first amplified signal, thereby generating a second amplified signal, and
a current amplifier circuit having a plurality of common collector amplifiers that are connected in cascade, and that are configured to receive the second amplified signal from said voltage amplifier circuit and to perform multiple stages of current amplifications on the second amplified signal, thereby generating one of the plurality of burst train driving signals.

11. The ultrasonic generator system as claimed in claim 8, wherein the burst signal parameter set further includes a waveform count value, and the single-cycle waveform is outputted for a number of times equal to the waveform count value when said signal generator is outputting the single-cycle waveform repeatedly in the continuous manner.

12. The ultrasonic generator system as claimed in claim 8, wherein the burst signal parameter set further includes a plurality of delay parameter values that correspond respectively to the plurality of burst train signals; and
wherein for each of the plurality of burst train signals, said signal generator is configured to generate the burst train signal after a delay time, and a length of the delay time is positively correlated to the respective one of the plurality of delay parameter values.

13. The ultrasonic generator system as claimed in claim 8, wherein the at least one single-cycle waveform parameter value includes a plurality of single-cycle waveform parameter values that correspond respectively to the plurality of burst train signals; and
wherein for each of the plurality of burst train signals, the number of said plurality of data points that are used by said signal generator to determine the single-cycle waveform is equal to the respective one of the plurality of single-cycle waveform parameter values.

14. The ultrasonic generator system as claimed in claim 8, wherein said signal generator is further configured to, when said signal generator is outputting the single-cycle waveform repeatedly in the continuous manner, automatically update the number of said plurality of data points and re-determine the single-cycle waveform based on said plurality of data points that have been updated.

15. The ultrasonic generator system as claimed in claim 8, wherein, said signal generator is further configured to, after said signal generator outputs the single-cycle waveform repeatedly in the continuous manner, and before said signal generator repeats the steps of outputting the single-cycle waveform repeatedly in the continuous manner and stopping output of the single-cycle waveform for the second predetermined time length, automatically update the number of said plurality of data points and re-determine the single-cycle waveform based on said plurality of data points that have been updated.

16. The ultrasonic generator system as claimed in claim 8, wherein said signal generator is configured to selectively operate in one of a multi-phase burst mode, a multi-frequency burst mode, and a chirp mode;
wherein when said signal generator is operating in the multi-phase burst mode, the burst signal parameter set further includes a plurality of delay parameter values that are unique and that correspond respectively to the plurality of burst train signals, and for each of the plurality of burst train signals, said signal generator is configured to generate the burst train signal after a delay time based on the respective one of the plurality of delay parameter values, thereby making the single-cycle waveforms of the plurality of burst train signals have different starting times;
wherein when said signal generator is operating in the multi-frequency burst mode, the at least one single-cycle waveform parameter value includes a plurality of single-cycle waveform parameter values that are unique and that correspond respectively to the plurality of burst train signals, and for each of the plurality of burst train signals, said signal generator is configured to determine the single-cycle waveform according to the respective one of the plurality of single-cycle waveform parameter values; and
wherein when said signal generator is operating in the chirp mode, for each of the plurality of burst train signals, said signal generator automatically updates a corresponding one of the at least one single-cycle waveform parameter value in one of an incremental and a decremental manner, so that the number of said plurality of data points that are used to determine the single-cycle waveform are updated in one of the incremental and the decremental manner.

17. The ultrasonic generator system as claimed in claim 16, wherein when said signal generator is operating in the multi-frequency burst mode, a distribution length along a Z-axis of a focal position, which is formed by a constructive interference of the ultrasonic beams that are outputted respectively through said plurality of ultrasonic output surfaces onto a target space, is related to a frequency difference between the ultrasonic beams, and the distribution length of the focal 10 position along the Z-axis is adjustable.
